(19) United States
(12) Patent Application Publication
(10) Pub. No.: US 2017/0208777 A1
(43) Pub. Date: Jul. 27, 2017

(54) PORTABLE COLLECTING ROD

(71) Applicant: HSI-YING CHIU, Taoyuan (TW)

(72) Inventor: Hsi-Ying Chiu, Taoyuan (TW)

(21) Appl. No.: 15/002,479

(22) Filed: Jan. 21, 2016

(51) Int. Cl. A01K 23/00; F21V 33/00; A01K 77/00; A01K 29/00; A01M 3/00

(52) U.S. Cl. CPC A01K 23/005; A01K 29/00; A01M 3/002; A01K 77/00; F21V 33/004

(57) ABSTRACT

A portable collecting rod that includes a rod member; an external ring, which is connected to one end of the rod member; a flexible internal ring, which is connected to one end of the rod member provided with the external ring, and is correspondingly disposed at the inner position of the external ring. An endpoint of the flexible internal ring penetrates the interior of the rod member; and an operating member, one portion of which is disposed on the exterior of the rod member, and another portion is embedded in the interior of the rod member and is connected to the flexible internal ring. The user can movably deform and change the size of the flexible internal ring by operating the operating member.

### BACKGROUND OF THE INVENTION

(a) Field of the Invention

The present invention relates to a collecting device appropriate for collecting pet excrement, and more particularly relates to a portable collecting rod that uses a method whereby a user is able to directly retrieve and take away at a relatively long distance the excrement just discharged by a pet, thereby preventing pet excrement from falling to the ground and causing environmental pollution, as well as allowing the user to keep him/herself clean and hygienic. In addition, the present invention may also be used in capturing insects or fishing for fish and shrimps.

(b) Description of the Prior Art

Nowadays, there is an increasing number of people keeping pets, such as cats, dogs, and the like, and the pet owner is commonly seen taking their household pet for a walk outdoors. As for the pet, which lacks the slightest self-control, as soon as it needs to discharge excrement, it will resolve the matter on the spot of its own accord, leaving the excrement on the ground. This not only spoils the surrounding view but also produces an unpleasant odor that taints the air and seriously affects environmental sanitation.

In today's society where citizens are progressively attaching importance to the cleanness and sanitation of the external environment, the majority of advanced countries require that pet owners immediately remove the excrement discharged by their pet to maintain environmental sanitation. Hence, currently, when taking their pet outdoors, the majority of pet owners will generally also take along items such as paper, a plastic bag, and the like, in order to pick up the excrement discharged by their pet.

However, using items such as conventional paper, plastic bags, and the like, to pick up pet excrement that has already been discharged on the ground, not only creates the problems of easily dirtying the pet owner's hands and lacking sanitation, using a method of merely picking up the excrement is also unable to completely clean up the ground that has been polluted by pet excrement, thus causing environmental pollution because part of the excrement still remains on the ground. Hence, in reality, there remain many shortcomings in conventional methods, thus, there is a need for improvement.

### SUMMARY OF THE INVENTION

In light of the aforementioned problems of the prior art, the primary object of the present invention is to provide a portable collecting rod that uses a method whereby a user is able to directly retrieve and take away at a relatively long distance the excrement just discharged by a pet, thereby preventing pet excrement from falling to the ground and causing environmental pollution, as well as allowing the user to keep him/herself clean and hygienic.

According to the primary object of the present invention, a portable collecting rod is disclosed comprising: a rod member, which is a hollow rod body; an external ring, which is connected to one end of the rod member; a flexible internal ring, which is connected to the end of the rod member provided with the external ring, and is correspondingly disposed at an inner position of the external ring, moreover, the flexible internal ring forms a shape corresponding to the external ring, and an endpoint of the flexible internal ring penetrates the interior of the rod member; and an operating member, one portion of which is disposed on the exterior of the rod member, and another portion is embedded in the interior of the rod member. The operating member is connected to the flexible internal ring, and the user is able to movably deform and change the size of the flexible internal ring by operating the operating member, whereby the flexible internal ring presses against or separates from the external ring, with the result that the external ring and the flexible internal ring are able to movably clasp a holding member there between.

It is preferable that the rod member is provided with a slide groove, with the slide groove enabling the operating member to be disposed therein. The operating member may movably slide within the slide groove to enable displacement of the operating member therein to control the flexible internal ring.

It is preferable that the holding member is, for example, a bag or a net.

It is preferable that the portable collecting rod further comprises a gripping tube, which is mounted on another end opposite to where the external ring is connected to the rod member.

It is preferable that the portable collecting rod further comprises a loop end, which is joined to one end of the gripping tube mounted on the rod member.

It is preferable that the gripping tube is, for example, made from rubber.

It is preferable that the portable collecting rod further comprises a joining member, which is mounted on the body of the rod member. And the joining member is provided with an embedding portion and a fastening member to enable a scoop to movably clasp thereto.

It is preferable that the portable collecting rod further comprises a hanging member, which is disposed on the operating member. And the hanging member may be a hook or a retaining ring.

It is preferable that the hanging member and the operating member are structured to form a single body.

It is preferable that the portable collecting rod further comprises a luminescent module, which is disposed on the rod member.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a first schematic view of a first embodiment of a portable collecting rod of the present invention.

FIG. 2 is a second schematic view of the first embodiment of the portable collecting rod of the present invention.

FIG. 3 is a third schematic view of the first embodiment of the portable collecting rod of the present invention.

FIG. 4 is a fourth schematic view of the first embodiment of the portable collecting rod of the present invention.

FIG. 5 is a first schematic view of a second embodiment of the portable collecting rod of the present invention.

FIG. 6 is a second schematic view of the second embodiment of the portable collecting rod of the present invention.

FIG. 7 is a schematic view of a third embodiment of the portable collecting rod of the present invention.

### DETAILED DESCRIPTION OF THE PREFERRED EMBODIMENTS

In order for the patent officer to understand the characteristics of the art, contents, and advantages of the present invention and effectiveness achieved, a description of the embodiments together with the drawings of the present invention is described in detail below.

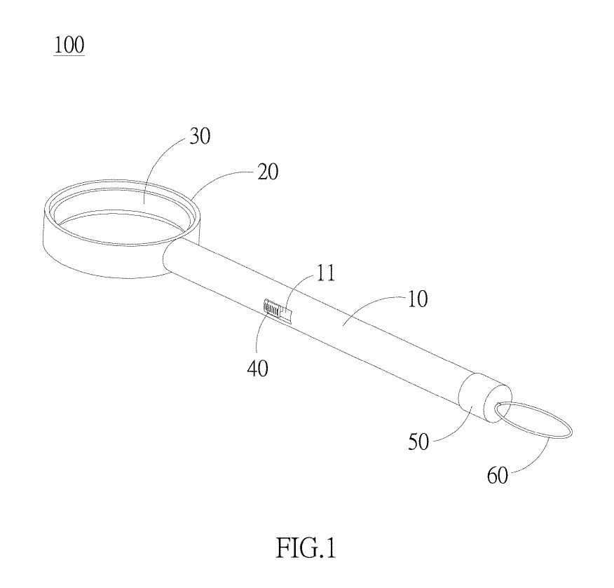

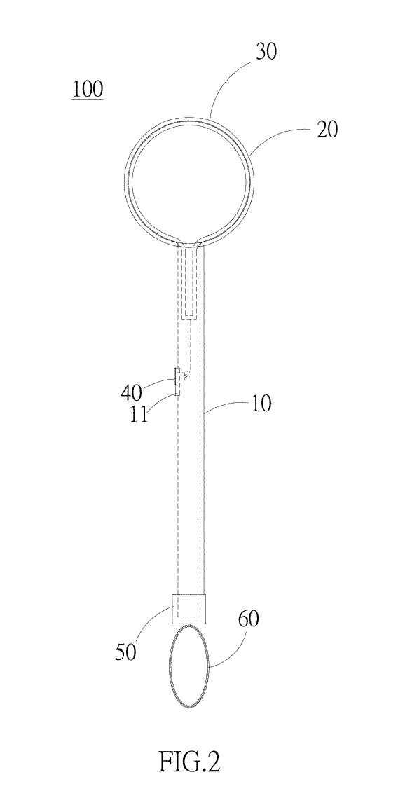

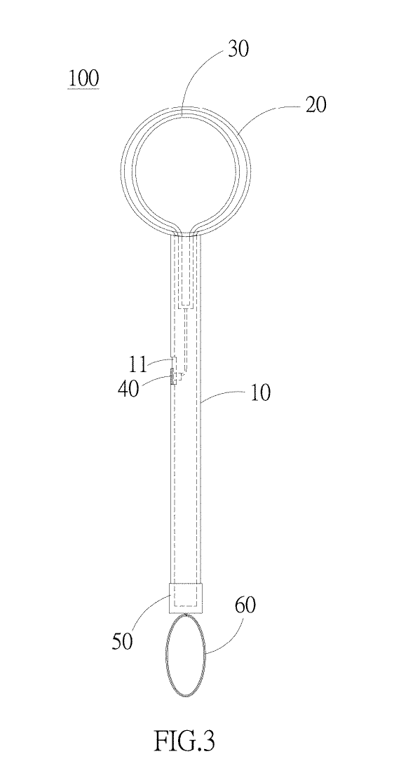

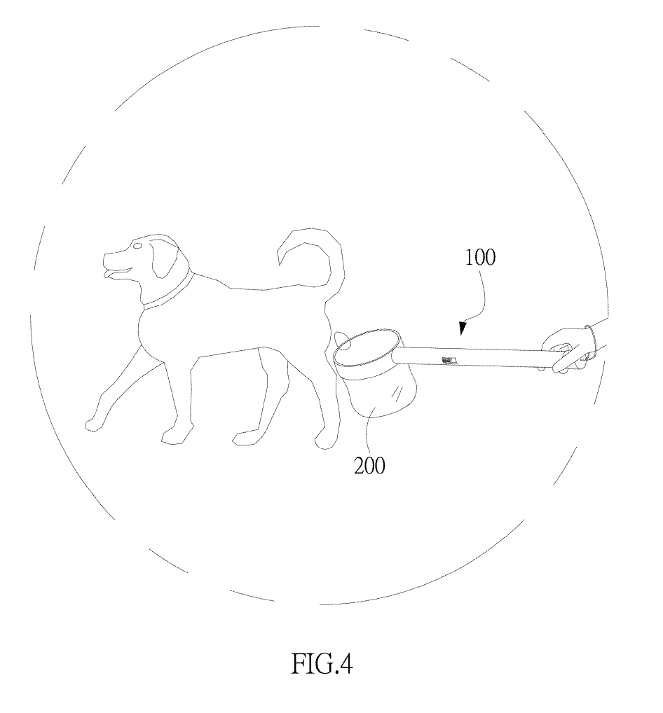

Referring to FIGS. 1 to 4, which respectively show a first schematic view, a second schematic view, a third schematic view, and a fourth schematic view of a first embodiment, respectively, of a portable collecting rod of the present invention. Wherein a portable collecting rod 100 primarily comprises a rod member 10, an external ring 20, a flexible internal ring 30, and an operating member 40. Moreover, the portable collecting rod 100 further comprises a gripping tube 50 and a loop end 60. The rod member 10 is a hollow rod body, one end of which is connected to the external ring 20 and the flexible internal ring 30. The flexible internal ring 30 is correspondingly disposed at the inner position of the external ring 20, and the flexible internal ring 30 forms a shape corresponding to the external ring 20, for example, the shape may be circular, but is not limited by such. One portion of the operating member 40 is disposed on the exterior of the rod member 10 to facilitate touch control by the user. Another portion of the operating member 40 is embedded in the interior of the rod member 10. and is connected to an endpoint of the flexible internal ring 30 penetrating the interior of the rod member 10. The operating member 40 facilitates operation by the user to control deformation and change in size of the flexible internal ring 30, thereby enabling the flexible internal ring 30 to tighten against or separate from the external ring 20, and further enabling a holding member 200 to be movable clasped between the external ring 20 and the flexible internal ring 30. Accordingly, the user is able to use the firmly clasped holding member 200 to receive excrement being discharged by a pet, as depicted in FIG. 4. Wherein the holding member 200, for example, is a net or a bag.

In the aforementioned description, a slide groove 11 may be further provided in the surface of the rod member 10 so as to pass through to the interior thereof. The slide groove 11 enables the operating member 40 to be disposed therein. The operating member 40 is able to move within the slide groove 11, thereby enabling the user to control the annular form of the flexible internal ring 30. For example, when the user slides the operating member 40 toward one end of the slide groove 11, the flexible internal ring 30 enlarges to press and tighten against the external ring 20. Furthermore, under the tightened state of the flexible internal ring 30 and the external ring 20 firmly clasping the holding member 200, when the user slides the operating member 40 toward the other end of the slide groove 11, the flexible internal ring 30 is caused to reduce in size and thus separate from the external ring 20, thereby causing the holding member 200 to separate from the flexible internal ring 30 and the external ring 20. Wherein, the operating member 40 may also control the flexible internal ring 30 using a pressing method, but is not limited to such a method.

In addition, the gripping tube 50 is further mounted on another end opposite to the external ring 20 and the flexible internal ring 30 fitted on one end of the rod member 10, and the gripping tube 50 is preferably made from rubber providing an anti-slip effect. The gripping tube 50 enables the user to grip the rod member 10. Moreover, the loop end 60 is further fitted to one end of the gripping tube 50 mounted on the rod member 10. The user is able to pass their hand through the loop end 60, thus enabling the rod member 10 to hang from the user's hand, allowing the user greater convenience in use and preventing the portable collecting rod 100 from falling from the hand when being carried.

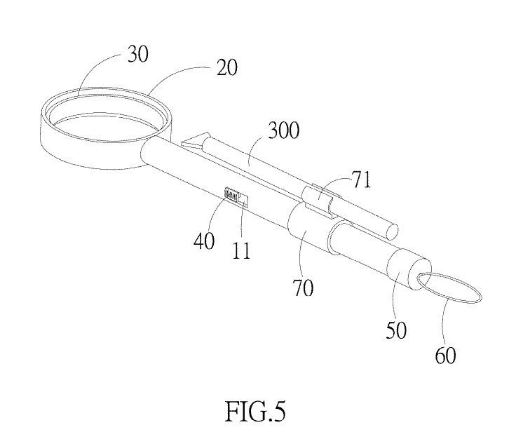

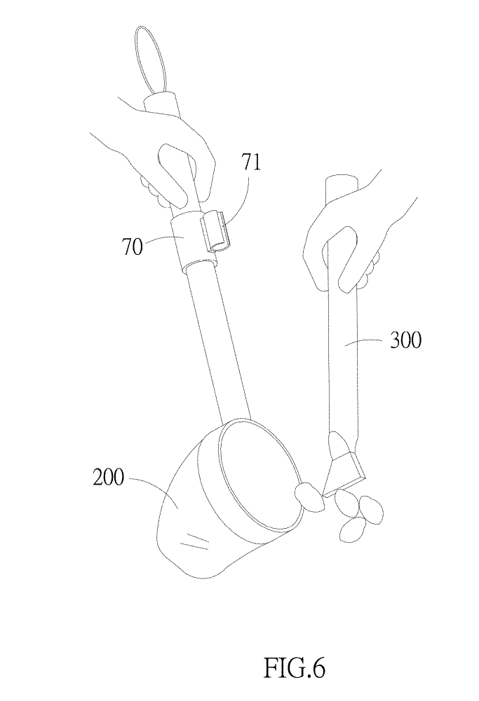

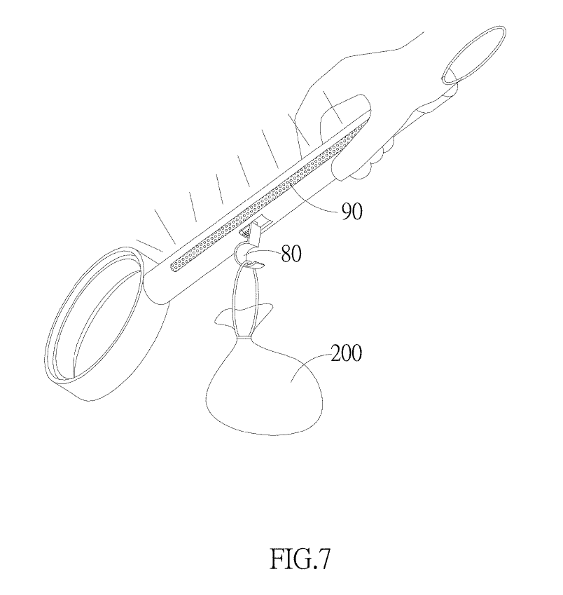

Furthermore, referring to FIGS. 5 to 7, wherein FIG. 5 and FIG. 6 respectively show a first schematic view and a second schematic view of a second embodiment of the portable collecting rod 100 of the present invention; and FIG. 7 shows a schematic view of a third embodiment of the portable collecting rod 100 of the present invention. In the second embodiment, the portable collecting rod 100 of the present invention further comprise a joining member 70, and the joining member 70 is movably mounted on the body of the rod member 10. Moreover, the joining member 70 is provided with an embedding portion 71 and a fastening member (not shown in the drawings). The fastening member is used to fixedly mount the joining member 70 onto the rod member 10, and the embedding portion 71 is used to movably clasp a scoop 300 thereon. If pet excrement is discharged onto the ground, then the scoop 300 can be used to shovel up the excrement, thus eliminating the need to use paper or a plastic bag to pick up the excrement. In the third embodiment, the portable collecting rod 100 of the present invention further comprises a hanging member 80 and a luminescent module 90. The hanging member 80 is disposed on the operating member 40, and it is preferable that the hanging member 80 and the operating member 40 are designed so as to form an integral body. The hanging member 80 is used to hook the holding member 200. The hanging member 80 may be a hook or a retaining ring. The luminescent module 90 is disposed on the rod member 10 and functions as a luminescent source, allowing the user to use the portable collecting rod 100 as a lighting device when taking their pet outdoors at night.

In conclusion, the portable collecting rod 100 of the present invention can be carried by the user when taking their dogs for a walk outdoors, and provides the user with a method to receive and scoop up at a relatively long distance the excrement just discharged by their dogs, thereby eliminating the need to pick up the excrement from the ground using toilet paper. The present invention not only maintains environmental sanitation, and avoids having to directly take away the excrement using a method involving the hands and, thus, dirtying the pet owner, but also maintains cleanness and personal hygiene of the user when outdoors. It is understood that the portable collecting rod of the present invention may also be used for the purpose of capturing insects or fishing for fish and shrimps.

Summarizing the above, in overcoming structural shortcomings of the prior art, it can be seen that the present invention has assuredly achieved effectiveness of anticipated advancement, and, moreover, is easily understood by persons unfamiliar with the art. Furthermore, contents of the present invention have not been publicly disclosed prior to this application. The practicability and advancement of the present invention clearly comply with the essential elements as required for a new patent application, accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

1. A portable collecting rod, comprising:
a rod member, the rod member is a hollow rod body;
an external ring, the external ring is connected to one end of the rod member;
a flexible internal ring, the flexible internal ring is connected to one end of the rod member fitted with the external ring, and is correspondingly disposed at an inner position of the external ring; the flexible internal ring forms a shape corresponding to the external ring, and an endpoint of the flexible internal ring penetrates an interior of the rod member;
an operating member, one portion of the operating member is disposed on an exterior of the rod member, another portion of the operating member is embedded in the interior of the rod member and is connected to the flexible internal ring; control through the operating member enables deforming and changing the size of the flexible internal ring, whereby the flexible internal ring presses against or separates from the external ring, with the result that the external ring and the flexible internal ring are able to movably clasp a holding member there between; and
a hanging member, the hanging member is disposed on the operating member, and the hanging member may be a hook or a retaining ring.

2. The portable collecting rod according to claim 1, wherein the rod member is provided with a slide groove, and the slide groove enables the operating member to be disposed therein, the operating member is thus able to movably slide within the slide groove to cause displacement thereof to control the flexible internal ring.

3. The portable collecting rod according to claim 1, wherein the holding member is a bag or a net.

4. The portable collecting rod according to claim 1, wherein the portable collecting rod further comprises a gripping tube, and the gripping tube is mounted on another end opposite to where the external ring is connected to the rod member.

5. The portable collecting rod according to claim 4, wherein the portable collecting rod further comprises a loop end, and the loop end is joined to one end of the gripping tube mounted on the rod member.

6. The portable collecting rod according to claim 4, wherein the gripping tube is made from rubber.

7. The portable collecting rod according to claim 1, wherein the portable collecting rod further comprises a joining member, and the joining member is mounted on the body of the rod member, moreover the joining member is provided with an embedding portion and a fastening member, which are used to movably clasp a scoop thereon.

8. (canceled)

9. The portable collecting rod according to claim 1, wherein the hanging member and the operating member are structured to form an integral body.

10. The portable collecting rod according to claim 1, wherein the portable collecting rod further comprises a luminescent module, and the luminescent module is disposed on the rod member.
